(19) United States
(12) Patent Application Publication
(10) Pub. No.: US 2007/0226140 A1
(43) Pub. Date: Sep. 27, 2007

(54) Expedited Issuance and Activation of a Transaction Instrument

(75) Inventors: Glade R. Erikson, Glendale, AZ (US); Stacey J. Crawford, Murray, UT (US); Lorrell Arvanitas, Mesa, AZ (US); Jon C. Patton, Sandy, UT (US); Vernon Marshall, Montclair, NJ (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc., New York, NY (US)

(21) Appl. No.: 11/277,452

(22) Filed: Mar. 24, 2006

(51) Int. Cl. G06Q 40/00

(52) U.S. Cl. 705/41

(57) ABSTRACT

A method and computer program code for expediting issuance and activation of transaction instruments upon application therefor. A first set of application information is collected from an applicant. The first set of application information is processed to determine whether all required information has been obtained. If the first set of application information, comprises all information required to issue and activate the transaction instrument, then the application process is completed, the transaction instrument is provided to the applicant, and the applicant is permitted to automatically activate the transaction instrument upon receipt. If the first set of application information comprises less than all information required to issue and activate the transaction instrument, then the application process is completed and the transaction instrument is provided to the applicant in an unactivated state. The applicant is required to communicate with the transaction instrument issuer to provide the issuer with a second set of required application information. The accuracy of the second set of required application information is verified, and then the transaction instrument is activated after the second set of required application information has been verified.

### BACKGROUND OF THE INVENTION

1. Field of the Invention

The present invention relates to systems and methods for expediting the issuance and activation of transaction instruments, such as charge cards, credit cards, debit cards, etc.

2. Background Art

Credit cards, charge cards, and other transaction instruments are commonly accepted today as a form of payment under a variety of circumstances. A transaction instrument may be used to make a purchase in-person, for example, at a retail store, a restaurant, or a hotel by physically presenting a merchant with the transaction instrument. A transaction instrument may also be used to make a purchase without physically presenting the instrument, by relaying information associated with the transaction instrument, such as an account number, account name, expiration date, and billing address, to a merchant. Examples of merchants that accept transaction instruments as payment without physically receiving the transaction instrument include internet, telephone, and mail-order merchants, airlines, car rental companies, and the like.

Today, many businesses open transaction instrument accounts in their own names. This facilitates the ability of employees to make purchases or incur travel expenses, without expending cash money. These accounts also allow the business to keep accurate track of employee spending.

Typically, when a business entity wants to open a transaction instrument account, such as a credit card, charge card, or debit card account, an employee of the company will contact the financial services company that sponsors the instrument, such as American Express, Diner's Club, Citibank, Bank of America, etc. The contact can be made by telephone, by filling out a paper application and mailing it to the financial services company, or by completing an on-line internet application. Following enactment of the USA PATRIOT Act, Public Law No. 107-56, the federal government has required financial service institutions to collect certain specific information prior to issuing transaction instruments. Chief among the information required by the PATRIOT Act is the tax identification number (TIN) of the business entity making application for the transaction instrument. It is often the case that the person applying for the business entity transaction instrument does not have the TIN at the time that the application is being completed. In that event, the financial services institution, upon receipt of the mailed or on-line application, will attempt to contact the customer applying for the instrument prior to sending the physical instrument to the customer. This often results in substantial delays in completing the application and issuing and activating the instrument. If the financial services institution is unable to contact the customer within a reasonable amount of time, the application may be cancelled, requiring the customer to re-initiate an application. This results in frustration on the customer's part, and extra work on the part of the issuing organization.

What is needed, therefore, is a system and method for expediting the issuance and activation of a transaction instrument.

### BRIEF SUMMARY OF THE INVENTION

The present invention is directed to a method and computer program product for expediting issuance and activation of transaction instruments upon application therefor. A first set of application information is collected from an applicant. The first set of application information is processed to determine whether all required information has been obtained. If the first set of application information comprises all information required to issue and activate the transaction instrument, then the application process is completed, the transaction instrument is provided to the applicant, and the applicant is permitted to automatically activate the transaction instrument upon receipt. If the first set of application information comprises less than all information required to issue and activate the transaction instrument, then the application process is completed and the transaction instrument is provided to the applicant in an unactivated state. The applicant is required to communicate with the transaction instrument issuer to provide the issuer with a second set of required application information. The accuracy of the second set of required application information is verified, and then the transaction instrument is activated after the second set of required application information has been verified.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flowchart showing a first embodiment of a transaction instrument issuance.

FIG. 2 is a flowchart in accordance with the first embodiment showing the data-gathering and activation process.

FIG. 3 is a flowchart in accordance with the first embodiment showing action if an application is not activated.

FIG. 4 shows a second embodiment of a transaction instrument issuance.

FIG. 5 is a flowchart in accordance with the second embodiment showing alternative methods of activating a transaction instrument.

FIG. 6 is a flowchart in accordance with the second embodiment showing data gathering and card activation process.

FIG. 7 is a flowchart showing card replacement, maintenance, and adding supplemental cards or balance transfers to an activated account according to the second embodiment.

FIG. 8 is a flowchart showing cancellation of the account according to the second embodiment.

FIG. 9 is a block diagram of a computer system on which the present invention can be implemented.

### DETAILED DESCRIPTION OF THE INVENTION

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

Terminology

The terms “merchant” as used herein means any person, entity, distributor system, software, and/or hardware that is a provider, broker, and/or any other entity in the distribution chain of goods or services. For example, a merchant may be a credit card issuer, a hotel chain, an airline, a grocery store, a retail store, a travel agency, a service provider, an online merchant, or the like.

A “transaction account” as used herein refers to an account associated with an open account card or a closed account card system (as described below). The transaction account may exist in a physical or non-physical embodiment. For example, a transaction account may be distributed in non-physical embodiments such as an account number, frequent-flyer account, telephone calling account or the like. Furthermore, a physical embodiment of a transaction account may be distributed as a financial instrument.

The term “transaction instrument” as used herein may include any type of open or closed charge card, credit card, debit card, stored value card, an RFID chip based card or token, and the like. For convenience, a transaction instrument may be referred to as a “card.”

“Open cards” are financial transaction cards that are generally accepted at different merchants. Examples of open cards include the American Express®, Visa®, MasterCard® and Discover® cards, which may be used at many different retailers and other businesses. In contrast, “closed cards” are financial transaction cards that may be restricted to use in a particular store, a particular chain of stores or a collection of affiliated stores. One example of a closed card is a card that may only be accepted at a clothing retailer, such as a Saks Fifth Avenue ® store.

An “account,” “account number” or “account code”, as used herein, may include any device, code, number, letter, symbol, digital certificate, smart chip, digital signal, analog signal, biometric or other identifier/indicia suitably configured to allow a consumer to access, interact with or communicate with a financial transaction system. The account number may optionally be located on or associated with a financial transaction instrument (e.g., rewards, charge, credit, debit, prepaid, telephone, embossed, smart, magnetic stripe, bar code, transponder, radio frequency card or payment statement).

Persons skilled in the relevant arts will understand the breadth of the terms used herein and that the exemplary descriptions provided are not intended to be limiting of the generally understood meanings attributed to the foregoing terms.

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to effect such feature, structure, or characteristic in connection with other embodiments whether or not explicitly described.

Overview

The invention relates to a system and method for expediting the issuance and activation of transaction instruments, primarily credit cards, charge cards, and debit cards. Typically, when a person or business entity applies for a card, they must complete an application furnished by the card issuer. Certain information is fundamentally required by the card issuer before the issuer will even send a card to the applicant. Until that fundamental required information is furnished by the customer, the card issuer will place a hold on the application.

The issuer will then make an effort to contact the customer to obtain the required information and complete the application process. Often it will require several attempts to contact the customer. They may not be at home or at their office desk; they may be traveling and unavailable for a period of time, etc. This delays the application and card issuance process. Once the card issuer is finally able to contact the customer, the issuer must then complete the application process, establish an account for the customer in the issuer's accounts receivable system, and mail the card to the customer. When the customer receives the card, they must then call the card issuer's activation number to activate the card and permit its use.

The conventional process causes delays in activation and use of the card. This causes inconvenience to the customer because he/she is without use of the card for an extended period of time. The card issuer is also inconvenienced by the loss of a revenue stream for the period of time the customer is unable to use his/her card.

The present invention obviates these delays. When a customer applies for a card and completes the issuer's application form with at least a minimal amount of necessary information, the issuer will process the application and establish an account for the customer. At the same time, the issuer will authorize the mailing of the physical (plastic) card to the customer. As with most modern day cards, the card is mailed in an unactivated state. To activate the card, the customer must call an activation number that is usually printed on a removable strip adhered to the card. In the present invention, when the customer calls to activate the card, the system detects that required information has not been entered into the application. The activation call is then routed to a customer service representative who can immediately obtain the required information to complete the application. Once all required information has been obtained and entered into the system, the card can be promptly activated.

An advantage of the present invention is that the card issuer does not have to chase the customer to obtain required information to complete the application. Rather, the issuer can send a card to the customer and wait for the customer to call to activate the card.

### Embodiments

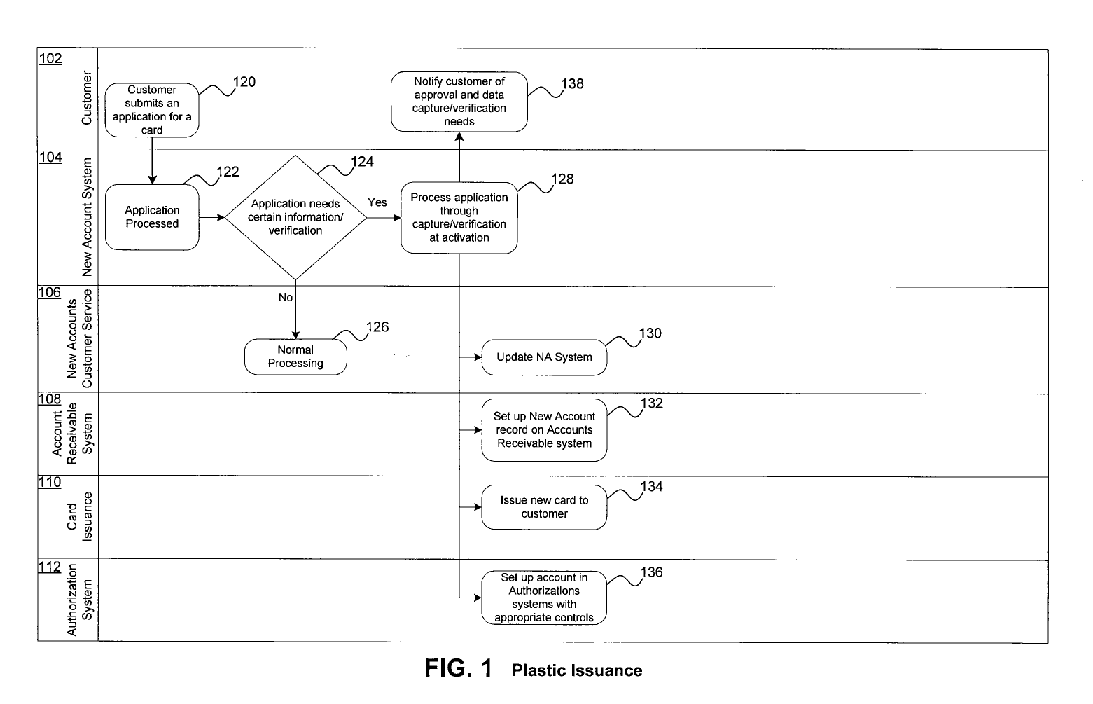

FIG. 1 is a flowchart showing the process for issuing a card in accordance with a first embodiment of this invention. The rows of the chart are called, for convenience, “swim lanes.” Swim lanes denote the activity or activities that are performed by the designated system or team. Lane 102 represents customer interaction. Lane 104 represents operations performed by the New Account System. Lane 106 represents operations performed by new accounts customer service. Lane 108 represents operations performed by the accounts receivable system. Lane 110 represents operations performed by the card-issuance service. Lane 112 represents operations performed by the authorization system. Typically, Customer Service 106 is handled by people, whereas the other lanes are primarily automated and performed on computer implementations.

The flow of operations starts at step 120, during which the customer submits an application for a card to a financial institution (or other card issuer). The application may be submitted by telephone, by mail, or through an interactive web page on the internet. At step 122, the application is processed by New Account system 104. At step 124, the application is reviewed by New Account System 104 to determine whether certain information is still required. When filling out the application, the customer may have omitted certain necessary information required by the financial institution or some other entity to permit the issuer to issue a card. If system 104 determines that all necessary information has been completed on the application form, then the process proceeds to step 126 in New Accounts Customer Service lane 106 for normal processing of the application and issuance of the card.

If necessary information is missing, the application proceeds to step 128 in New Accounts System lane 104. At this step, instructions are provided to update the new accounts system at step 130, to set up a new account record in the Accounts Receivable system at step 132 in lane 108, to issue a new card to the customer at step 134, and to set up the account in the authorization system 112 with appropriate controls at step 136. The appropriate controls typically include blocking use of the card until all required information has been obtained and processed by the system. Also, step 138 provides instructions to notify the customer that the application has been approved, but that the card cannot be used until certain required information has been provided by the customer.

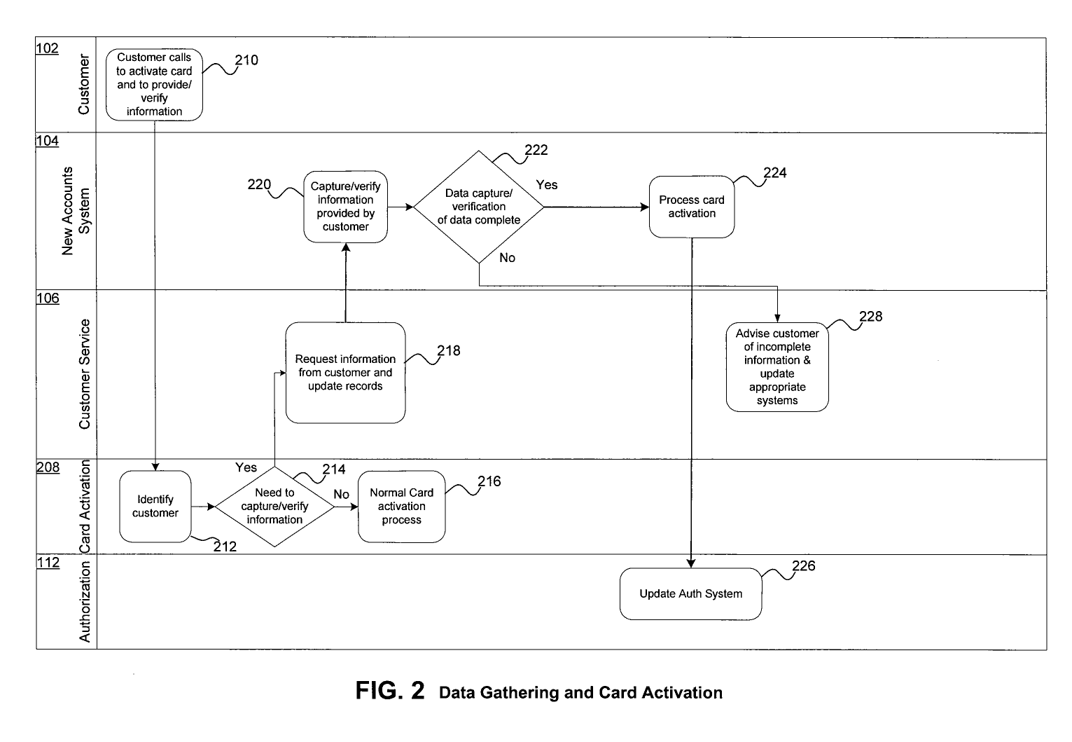

FIG. 2 is a flowchart showing the process for data gathering and card activation in accordance with the first embodiment. In addition to customer lane 102, New Accounts System lane 104, Customer Service lane 106, and Authorization lane 112, the Data Gathering and Activation process also includes a Card Activation lane 208.

Beginning at step 210, the customer calls to activate the card. At step 212, card activation system 208 obtains and verifies the identity of the customer. At step 214, a determination is made as to whether additional information is needed. If no additional necessary information is required, the process proceeds to step 216 for normal card activation. However, if additional necessary information is required, the process proceeds to step 218 where at Customer Service 106 a representative requests the additional necessary information from the customer. The customer provides additional necessary information to the Customer Service representative at step 218 where the information is entered and the customer's account is updated. At step 220, New Accounts System 104 captures and verifies the additional information provided by the customer. At step 222, a determination is then made by New Accounts System 104 to ensure that all necessary data has been captured and verified. If so, the process proceeds to step 224, and the card is processed to activation. Upon activation, the authorization system is updated at step 226 to remove the controls and permit spending on the card. At step 222, if more information is still required, the process proceeds to step 228, where Customer Service 106 informs the customer that necessary information is still missing and is required before the card can be activated.

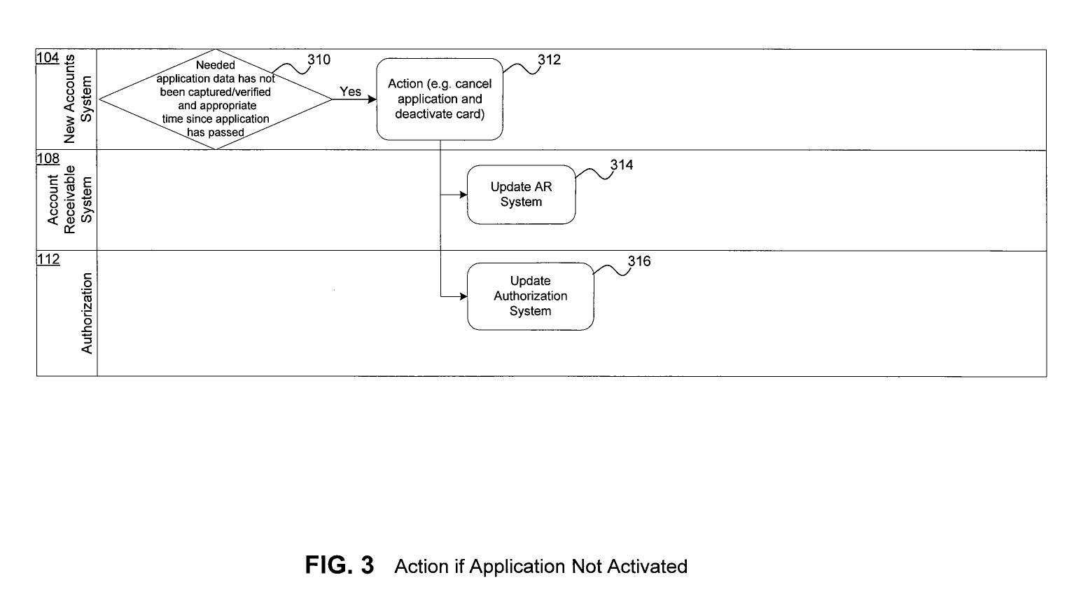

FIG. 3 is a flowchart showing the steps taken in the event the application is not completed and the card is not activated in accordance with the first embodiment. At step 310, the pending application is reviewed. After a predetermined time has passed, for example, from 10 days to 60 days, without completion of the application, the process moves to step 312. At this step, the application is reviewed and a determination is made whether sufficient information has already been provided to permit activation of the card, or whether the application must be cancelled for failure to provide certain necessary information. If the necessary information has not been provided by the customer, the process then moves to step 314 to update the accounts receivable system with the cancellation information, and to step 316 to update the authorization system to remove the account. Obviously, if the necessary information has been provided within the predetermined time frame, then the action taken at step 312 is to update the AR system at step 314 to show an activated card and to update the Authorization System at step 316 to activate the card and permit spending on it.

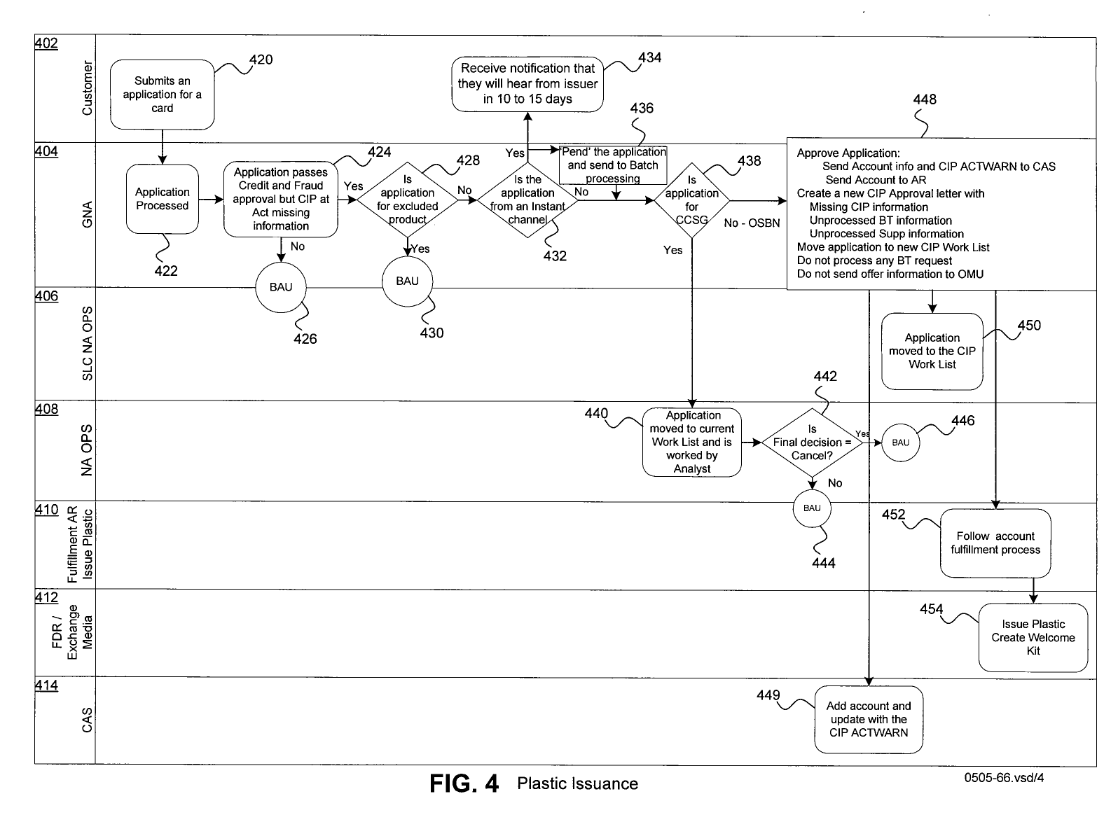

FIGS. 4-8 describe a second embodiment of the expedited card-issuance and activation system. Referring first to FIG. 4, as with the first embodiment, a number of swim lanes are shown. Lane 402 represents customer actions. Lane 404 represents the Global New Account (GNA) process operations. Lane 406 represents new account operations (SLC NA OPS) at a specific geographic site, performed by customer service personnel. In one example, American Express Company has its primary customer service personnel operations located in Salt Lake City, Utah. It will be apparent to persons skilled in the relevant art that the geographic location is not limiting, but is merely exemplary.

Lane 408 represents New Account Operations (NAOPS) performed by the system. Lane 410 represents the Fulfillment/Accounts Receivable/Issue Plastic operations, in which the account is set up in the accounts receivable system, the card is physically issued, and spending limits are placed on the account. FDR/Exchange Media Lane 412 represents operations of the entity that issues the physical plastic card and a welcome kit which are mailed to the customer. The plastic issuing entity may be a separate company from the card issuer. In one example, a company that manufactures the plastic and mails it to the customer is First Data Resources, of Omaha, Nebr. (FDR). Lane 414 represents operations of the Credit Authorization System (CAS). Typically, SLC NA OPS 406 is handled by people, whereas the other lanes are primarily automated and performed on computer implementations.

At step 420, a customer submits an application for a card, either by telephone, by mailing an application, or using an interactive website application form. At step 422, the application is processed by GNA system 404. At step 424, the application is screened for credit and fraud approval. In addition, a determination is made whether required information, part of the Customer Information Program (CIP) is missing. One example of CIP information is the tax identification number (TIN). The PATRIOT Act requires all card issuers to collect the TIN for new small business accounts before issuing and activating a card. Additionally, or alternatively, CIP information could include income information, social security number, and/or any other information the financial institution/card issuer deems necessary to complete the application and activate a new card.

If, at step 424, no CIP information is missing, that is, all required information has been provided by the customer, then the system proceeds to step 426 to process the card normally, using known business as usual (BAU) processes. If CIP information is missing, the process proceeds to step 428, where a determination is made whether the application is for a specific type of card that is excluded from the PATRIOT Act requirements or other card issuer requirements. In one example, used by American Express Company, one such card is called a total systems account (TSYS) card. If it is determined that this is an application for an excluded card (e.g., a TSYS card), the process proceeds to step 430 to process the application according to BAU. If the application is not for an excluded card, the process proceeds to step 432, where a determination is made whether the application is from an “instant channel.” An instant channel is one where the application is made through an interactive website application, or a point-of-sale (POS) location, such as at a retail store. In the present embodiment, instant channel applications are excluded from the expedited application approval process. It will be apparent to persons skilled in the relevant arts that instant channel applications could readily be included in the overall process of this invention.

If the application is determined to be from an instant channel, the process proceeds to step 434, at which the customer receives notification that they will be contacted by the card issuer at a later date, typically, but not necessarily, 5 to 15 days following the application date. At the same time, at step 436 the instant channel application is placed in a “pend” state in which a conditional approval is provided, pending the receipt of additional required information. The instant channel application is then sent to batch processing where it will be picked up by a customer service representative to contact the customer for the missing CIP information.

If at step 432, the application is not an instant channel application, or following the placement in step 436 of the instant channel application in a pend state, a determination is made at step 438 whether the application is for a Consumer Card Service Group (CCSG) card or for an Open Small Business Network (OSBN) card. The CCSG represents applications and accounts for individuals. The OSBN represents small business applications and accounts.

If the application is for a CCSG card, then at step 440, the application is moved to a current work list where it is acted on by an analyst in the New Accounts Operations lane 408. The analyst determines whether all information necessary for a CCSG application has been provided. At step 442, the analyst determines whether the application should be processed to completion and activation or should be canceled. In either case, whether the CCSG application should be approved or cancelled, it is then processed by BAU steps 444 or 446, respectively.

Returning to step 438, if the application is for an OSBN card, then at step 448 the application is approved in GNA system 404. At step 449, the account information and a CIP activity warning (ACTWARN) are sent to the credit authorization system (CAS) 414 to add the new account to the CAS and update the new account with the CIP ACTWARN information. The ACTWARN is an activity warning that provides the control on the CAS to prohibit spend authorization on the new account. Also at step 448, a CIP approval letter is created which identifies the missing CIP information.

At step 450, the application is moved to a CIP work list in SLC NA OPS lane 406. The CIP work list is equivalent to an “in-box” or a queue in GNA system 404. When a customer calls to activate the card (as will be discussed in more detail below), a customer service representative at SLC NA OPS 406 will access the application in the CIP work list to insert the missing CIP information. If a customer does not call to activate the card within a predetermined period of time, typically 14-19 days after the card has been mailed, as described at step 452 below, a customer service representative will usually try to contact the customer to complete the application process.

At step 452, the new account is added to the Accounts Receivable system in lane 410. Once the new account is added to the AR system, the plastic issuing entity (e.g., FDR) is instructed to send out the plastic card in lane 412 at step 454.

Referring back to step 448, when a new account having a CIP ACTWARN on it is processed, GNA system 404 will not generate certain information that would otherwise be generated where an application is complete and all necessary information has been provided. For example, a complete application that is not tagged with an ACTWARN would be typically processed and sent to an offer and marketing unit (OMU) to generate an approval letter to the customer that includes various cross-selling offers that are ancillary to the card. Such ancillary offers may, for example, include an offer to transfer balances from other cards to the new card, as well as offers to provide supplemental cards to, for example, other family members or business colleagues or employees. The OMU typically offers such card benefits as flight and baggage insurance and membership in rewards programs.

However, at this point, an account having a CIP ACTWARN on it will not be sent to the offer and marketing unit (OMU) to generate cross-selling offers to the customer. The OMU will not be activated for the CIP ACTWARN account until all necessary information has been provided and the CIP ACTWARN has been removed from the account.

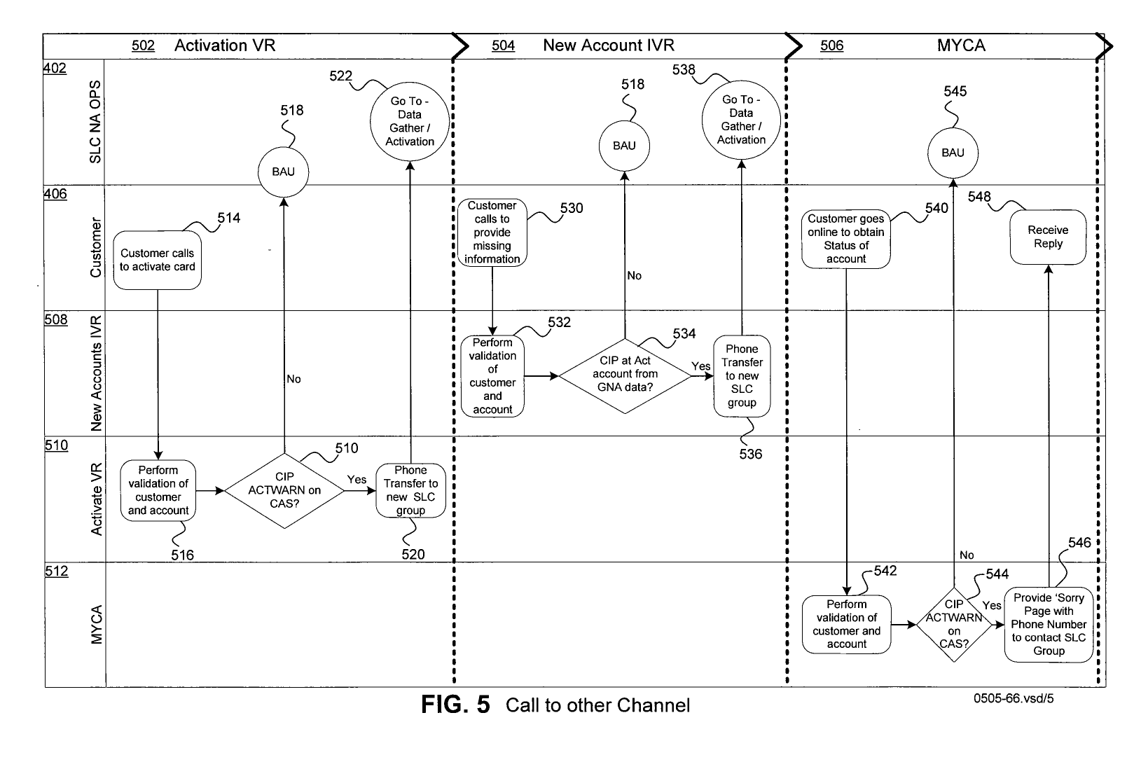

FIG. 5 is a flowchart in accordance with the second embodiment showing the process that occurs when a customer attempts to activate an account having a CIP ACTWARN on it. FIG. 5 shows three possible avenues of card activation. Column 502 shows the activation voice response (Activation VR) process when the customer calls the activation telephone number typically found on a strip on the back of the card. This number usually connects the caller to an automated computer voice response system (e.g., “for activation, press 1”; “for customer service, press 2”; etc.) Column 504 shows the Activation Inbound Voice Response (Activation IVR) process performed when the customer calls the activation number. In this case, the customer does not have a card in hand, but is calling in response to a letter received from the card issuer. The system recognizes that there is a CIP ACTWARN on the account. Column 506 shows the process that occurs when the customer attempts to activate the card online.

The rows show the lanes representing various parts of the system that perform the several functions of the activation process. In addition to Customer lane 402 and SLC NA OPS lane 406, the process of FIG. 5 also includes a New Account IVR lane 508, an Activate VR lane 510, and an internet card activation (MYCA) lane 512.

Referring first to Activation VR column 502, at step 514, the customer calls the activation number typically found on a removable strip on the card. Upon connection, and at the appropriate voice prompts, the customer keys in his card number and other identifying information, such as, by way of example but not limitation, the last four digits of his social security number and/or the zip code of his billing address. At step 516, the system then validates the customer and account information. At step 510, the system determines whether the account has a CIP ACTWARN on CAS. If there is no CIP ACTWARN on the account, activation proceeds according to BAU step 518. Typically, this will be an automatic activation, as is well known to those skilled in the relevant arts.

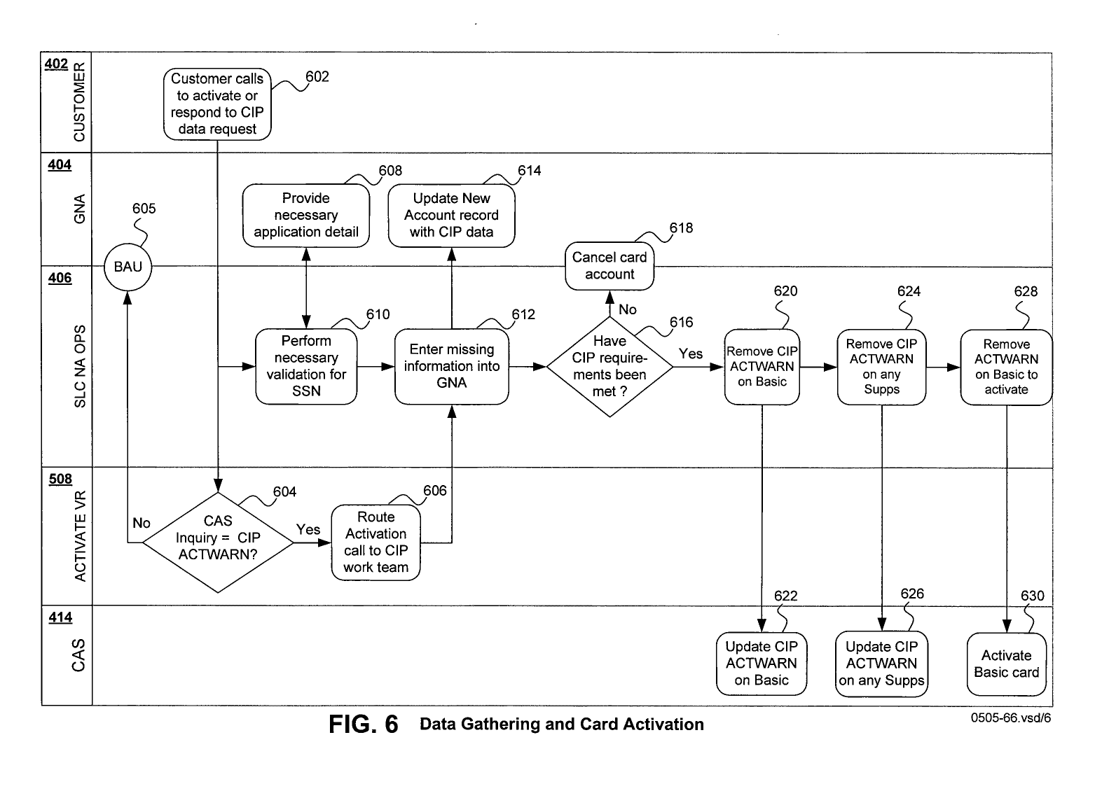

If the system detects a CIP ACTWARN on the account, then at step 520, the system transfers the call to the new account operations group in SLC NA OPS lane 406. At step 522, a customer service representative will speak with the customer to gather the required information necessary to complete the application and permit activation of the card. This data gathering process is described in detail below with reference to FIG. 6.

Referring next to New Account IVR column 504, this process is followed when the customer calls a number in response to a letter the customer has received. In this case, unlike the process followed in column 502, the customer does not have the card in hand. Under the process of column 504, the customer will have received a letter from the card issuer acknowledging the application and advising the customer that the application is incomplete. In this scenario, a card was not issued. In order to receive a card, the customer must call the card issuer to provide the missing CIP information. Once the missing information is provided and the application approved, the card is then sent to the customer to be activated in accordance with steps 514, 516 and 518 of the Activation VR process of column 502.

In the process of column 504, at step 530, the customer contacts the processing system at a number typically provided in a letter received from the card issuer. Upon connection to the processing system, the system performs a validation of the customer and the account at step 532. Once the account is verified, at step 534, the system determines whether there is an ACT WARN on the account. If there is no ACT WARN on the account, activation proceeds according to BAU at step 535. If the system detects a CIP ACTWARN on the account, then at step 536, the system will transfer the call to the SLC NA OPS in lane 406. At step 538, a customer service representative will speak with the customer to gather the required information necessary to complete the application and permit activation of the card in accordance with steps 514, 516, and 518. This data gathering process is described in detail below with reference to FIG. 6.

Turning now to column 506, here the customer goes online at step 540 to obtain account status. The system validates the customer and the account at step 542 in a manner well known to persons skilled in the art. Once the account is validated, a determination is made at step 544 whether the account has a CIP ACTWARN on CAS. If there is no CIP ACTWARN on the account, the process proceeds to step 545 to activate the card according to BAU. If there is a CIP ACTWARN on the account, the system then responds to the customer at step 546 and provides a reply at step 548 indicating that certain required information is missing and that the account cannot be activated online. The reply typically includes a telephone number for the customer to call to provide the required information. The data gathering process is described in detail below with reference to FIG. 6.

FIG. 6 is a flowchart showing the data gathering and card activation process in accordance with the second embodiment. At step 602, the customer calls to activate the card (in accordance with column 502 or 504 of FIG. 5), or calls in response to an online notification (in accordance with column 506 of FIG. 5). Upon connection, and at the appropriate voice prompts, the customer will key in their card number and other identifying information, such as, by way of example but not limitation, the last four digits of their social security number and/or the zip code of their billing address. The call is routed to the Activation VR lane 508, where a CAS inquiry is made at step 604 to identify CIP ACTWARN account status. If there is no CIP ACTWARN on the account, the card is processed to activation using BAU at step 605. If a CIP ACTWARN is on the account, then at step 606, the call is routed to a customer service representative at the SLC NA OPS in lane 406. In response to the customer call, and using the information entered by the customer at step 610, the GNA system in lane 404 compares the customer provided information with the GNA database and provides the necessary application detail information at step 608 to validate the account. At step 612, the customer service representative will enter the missing information into the GNA system, and the new account record in the GNA database will be updated at step 614 with the CIP data. At step 616, a determination is made whether all CIP requirements have been met. If not, at step 618 the card account is cancelled. If all necessary CIP information has been entered, then at step 620 the CIP ACTWARN on the account is removed on the basic account, and the CAS 414 is updated at step 622 to remove the CIP ACTWARN. At step 624, the CIP ACTWARN is removed on supplemental card accounts, and at step 626, the CAS is updated to remove the CIP ACTWARN on those supplemental card accounts. At step 628, the ACTWARN is removed on the basic account to activate it, and at step 630, the CAS activates the basic card.

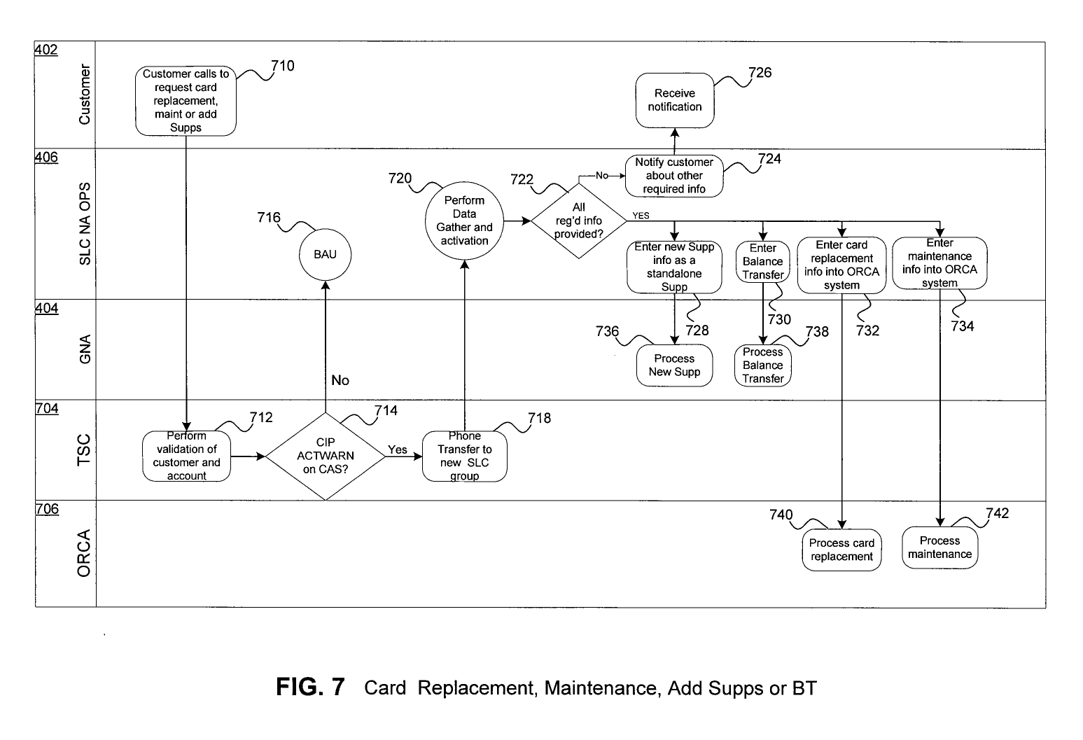

FIG. 7 shows the process in accordance with the second embodiment for card replacement, card maintenance, adding supplemental cards or balance transfer. In addition to customer lane 402, GNA system lane 404 and SLC NA OPS lane 406, FIG. 7 includes a Telephone Service Center (TSC) lane 704 and an Online Card Replacement (ORCA) lane 706. TSC lane 704 comprises customer service representatives similar to SLC NA OPS 406; ORCA 706 is a system similar to GNA system 404.

At step 710, the customer calls to request a replacement card, card maintenance, to add supplemental cards, or to request a balance transfer. At step 712, a customer service representative validates the customer and the account. At step 714, the account is reviewed to determine whether it has a CIP ACTWARN on CAS. If there is no CIP ACTWARN, then the process proceeds to step 716 to process the card according to BAU. If there is a CIP ACTWARN on the account, the process proceeds to step 718, and the phone call is transferred to the SLC NA OPS in lane 406. At step 720, an SLC NA OPS customer service representative gathers the required data needed to activate the card. At step 722, a determination is made whether all required information has been provided. If all required information has not been provided, the customer service representative notifies the customer at step 724 about additional information that is required, and the customer receives the notification at step 726. No further action to replace, maintain, add supplemental cards, or transfer balances is taken until the customer provides the required information. If all required information has been provided by the customer, then the process proceeds to one or more of steps 728, 730, 732, and 734. If a supplemental card has been requested, the information for the supplemental card is entered at step 728 and processed in GNA system 404 at step 736. If a balance transfer has been requested, the information is processed at step 730 and entered into GNA system 404 at step 738. If a replacement card has been requested, the information is entered into the ORCA system at step 732 and is processed by ORCA 706 at step 740. Lastly, if maintenance has been requested, such as a name change, card type change, etc., the information is entered into the ORCA system at step 734 and processed in ORCA 706 at step 742.

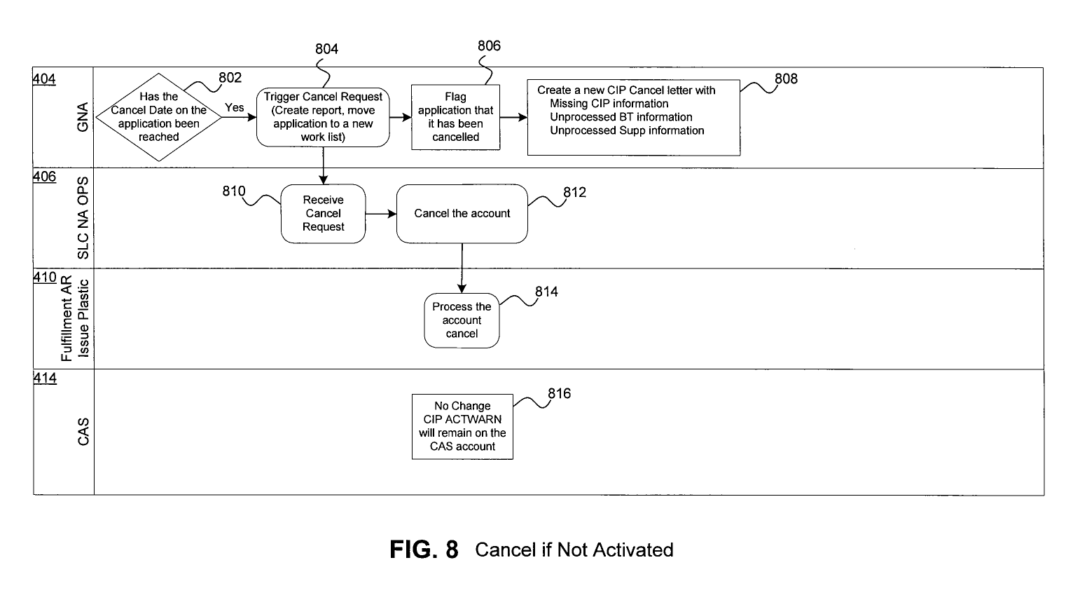

FIG. 8 is a flowchart showing the process in accordance with the second embodiment for cancelling an account if it is not activated within a predetermined period of time, for example, 60 days after the application has been made. At step 802, the application is checked to determine whether the cancellation date has been reached. If the cancellation date has been reached, then at step 804, a cancellation request is triggered in GNA system 404. The GNA system flags the application as being cancelled at step 806, and at step 808 creates a CIP cancel letter to be sent to the customer informing the customer of the cancellation and the missing CIP information. In addition, balance transfer and supplemental card information remains unprocessed.

At the same time, SLC NA OPS 406 receives the cancellation request at step 810 and cancels the account at step 812. The information is sent to the fulfillment/accounts receivable system 410 to process the account cancellation at step 814. No change is made to the CIP ACTWARN flag 816 on the account in the CAS 414. This flag remains on the account to prevent it from being reopened and activated at a later date without the missing CIP information.

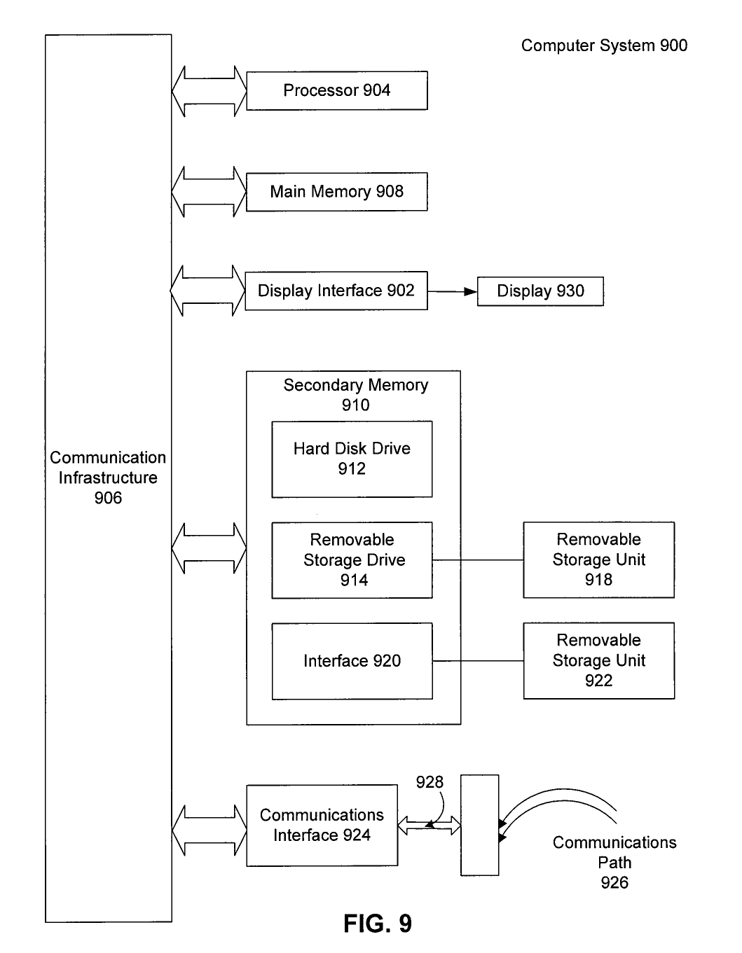

In one embodiment, the invention is directed toward one or more computer systems capable of carrying out the functionality described herein. An example of a computer system 900 is shown in FIG. 9.

Computer system 900 includes one or more processors, such as processor 904. Processor 904 is connected to a communication infrastructure 906 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 900 can include a display interface 902 that forwards graphics, text, and other data from communication infrastructure 906 (or from a frame buffer not shown) for display on display unit 916.

Computer system 900 also includes a main memory 908, preferably random access memory (RAM), and may also include a secondary memory 910. Secondary memory 910 may include, for example, a hard disk drive 912 and/or a removable storage drive 914, representing a floppy disk drive, a magnetic tape drive, an optical disk drive, etc. Removable storage drive 914 reads from and/or writes to a removable storage unit 918 in a well known manner. Removable storage unit 918 represents a floppy disk, magnetic tape, optical disk, etc. which is read by and written to by removable storage drive 914. As will be appreciated, removable storage unit 918 includes a computer usable storage medium having stored therein computer software and/or data.

In alternative embodiments, secondary memory 910 may include other similar devices for allowing computer programs or other instructions to be loaded into computer system 900. Such devices may include, for example, a removable storage unit 922 and an interface 920. Examples of such may include a program cartridge and cartridge interface (such as that found in video game devices), a removable memory chip (such as an erasable programmable read only memory (EPROM), or programmable read only memory (PROM)) and associated socket, and other removable storage units 922 and interfaces 920, which allow software and data to be transferred from removable storage unit 922 to computer system 900.

Computer system 900 may also include a communications interface 924. Communications interface 924 allows software and data to be transferred between computer system 900 and external devices. Examples of communications interface 924 may include a modem, a network interface (such as an Ethernet card), a communications port, a Personal Computer Memory Card International Association (PCMCIA) slot and card, etc. Software and data transferred via communications interface 924 are in the form of signals 928 which may be electronic, electromagnetic, optical or other signals capable of being received by communications interface 924. These signals 928 are provided to communications interface 924 via a communications path (e.g., channel) 926. This channel 926 carries signals 928 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 914, a hard disk installed in hard disk drive 912, and signals 928. These computer program products provide software to computer system 900. The invention is directed to such computer program products.

Computer programs (also referred to as computer control logic) are stored in main memory 908 and/or secondary memory 910. Computer programs may also be received via communications interface 924. Such computer programs, when executed, enable computer system 900 to perform the features of the present invention, as discussed herein. In particular, the computer programs, when executed, enable processor 904 to perform the features of the present invention. Accordingly, such computer programs represent controllers of computer system 900.

In an embodiment where the invention is implemented using software, the software may be stored in a computer program product and loaded into computer system 900 using removable storage drive 914, hard drive 912 or communications interface 924. The control logic (software), when executed by processor 904, causes processor 904 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention (e.g., packaging and activation of other transaction cards and/or use of batch activation processes). Thus, the present invention should not be limited by any of the above described exemplary embodiments, but should be defined only in accordance with the following claims and their equivalents.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method for expediting issuance and activation of transaction instruments upon application therefor, comprising:
(a) collecting a first set of application information from an applicant;
(b) processing said first set of application information to determine whether all required information has been obtained;
(c) if the first set of required application information comprises all information required to issue and activate the transaction instrument, then
completing the application process,
providing the transaction instrument to the applicant, and
permitting the applicant to automatically activate the transaction instrument upon receipt; and
(d) if the first set of application information comprises less than all information required to issue and activate the transaction instrument, then
completing the application process,
providing the transaction instrument to the applicant in an unactivated state,
requiring the applicant to communicate with the transaction instrument issuer to provide the issuer with a second set of required application information,
verifying the accuracy of the second set of required application information, and
thereafter activating the transaction instrument after the second set of required application information has been verified.

2. The method according to claim 1, wherein the second set of required application information includes a tax identification number.

3. The method according to claim 1, wherein step (d) further comprises providing a notification to the applicant that a second set of required application information is needed to complete the application process.

4. The method according to claim 3, further comprising cancelling the application without activating the transaction instrument if the applicant does not provide the second set of required application information to the transaction instrument issuer within a predetermined period of time.

5. The method according to claim 3, further comprising:
(e) establishing an account for the application in an authorization system;
(f) establishing a new account record for the application in an accounts receivable system; and
(g) updating a new account system with at least the first set of application information.

6. A method for activating a transaction instrument that has been issued to a customer following an application made by the customer for the transaction instrument, comprising:
(a) receiving a telephone communication from the customer;
(b) identifying the calling customer and matching the calling customer with the issued transaction instrument;
(c) determining whether there is a need to obtain required information from the customer; and
(d) if required information is needed, then
obtaining the required information from the customer,
entering the required information into a transaction instrument activation system,
verifying the required information obtained from the customer, and
activating the transaction instrument upon verification of the required information; or
(e) if no information is needed, then processing activation of the transaction instrument.

7. The method according to claim 6, wherein the required information includes a tax identification number.

8. The method according to claim 6, wherein if required information is needed, and the required information is not obtained from the customer, then canceling the customer's application without activating the transaction instrument.

9. The method according to claim 8, further comprising updating a credit authorization system upon cancellation of the customer's application.

10. A method for expediting transaction instrument issuance to a customer and activation of the transaction instrument, comprising:
(a) receiving, by a transaction instrument issuer, an application for the transaction instrument from the customer;
(b) processing the application by the transaction instrument issuer, including determining whether all required information has been supplied by the customer;
(c) if all required information has been supplied by the customer, then issuing the transaction instrument;
(d) if not all required information has been supplied by the customer, then
determining whether sufficient information has been supplied to issue the transaction instrument, and if so, then issuing the transaction instrument to the customer without activating the transaction instrument, and
notifying the customer that additional required information must be provided to the transaction instrument issuer prior to activation of the transaction instrument; and
(e) activating the transaction instrument if the customer responds to the notification within a predetermined period of time with the additional required information; or
(f) canceling the application if the customer does not respond to the notification within the predetermined period of time with the additional required information.

11. The method according to claim 10, wherein the additional required information includes a tax identification number.

12. The method according to claim 10, wherein step (e) further comprises:
validating the customer account information;
entering the additional required information into a transaction instrument authorization system;
validating the additional required information; and
thereafter activating the transaction instrument only if the additional required information is validated.

13. A computer program product comprising a computer usable medium having control logic stored therein for expediting issuance and activation of transaction instruments upon application therefor, comprising:
first computer readable program code for causing the computer to collect a first set of application information from an applicant;
second computer readable program code for causing the computer to process said first set of application information to determine whether all required information has been obtained;
third computer readable program code for causing the computer, if the first set of application information comprises all information required to issue and activate the transaction instrument, to
complete the application process,
provide the transaction instrument to the applicant, and
permit the applicant to automatically activate the transaction instrument upon receipt; and
fourth computer readable program code for causing the computer, if the first set of required application information comprises less than all information required to issue and activate the transaction instrument, to
complete the application process,
provide the transaction instrument to the applicant in an unactivated state,
verify the accuracy of a second set of required application information provided by the customer to the issuer upon communication therebetween, and
thereafter activate the transaction instrument after the second set of required application information has been verified.

14. The computer program product according to claim 13, wherein the second set of required application information includes a tax identification number.

15. The computer program product according to claim 13, wherein the fourth computer program code further comprises computer program code for providing a notification to the applicant that a second set of required application information is needed to complete the application process.

16. The computer program code according to claim 15, further comprising fifth computer program code for causing the computer to cancel the application without activating the transaction instrument if the applicant does not provide the second set of required application information to the transaction instrument issuer within a predetermined period of time.

17. The computer program code according to claim 15, further comprising:
fifth computer program code for causing the computer to establish an account for the application in an authorization system;
sixth computer program code for causing the computer to establish a new account record for the application in an accounts receivable system; and
seventh computer program code for causing the computer to update a new account system with at least the first set of required application information.

18. A system for activating a transaction instrument that has been issued to a customer following an application made by the customer for the transaction instrument, comprising:
means for receiving a telephone communication from the customer;
means for identifying the calling customer and matching the calling customer with the issued transaction instrument; and
means for determining whether there is a need to obtain required information from the customer; and
if required information is needed, then
obtaining the required information from the customer,
entering the required information into a transaction instrument activation system,
verifying the required information obtained from the customer,
activating the transaction instrument upon verification of the required information, or
if no information is needed, then processing activation of the transaction instrument.

19. The system according to claim 18, wherein the required information includes a tax identification number.

20. The system according to claim 18, further comprising means for canceling the customer's application without activating the transaction instrument if required information is needed, and the required information is not obtained from the customer.

21. The system according to claim 20, further comprising means for updating a credit authorization system upon cancellation of the customer's application.
